(19) United States
(12) Patent Application Publication
(10) Pub. No.: US 2025/0208898 A1
(43) Pub. Date: Jun. 26, 2025

(54) VEHICULAR DEVICE AND CONTROL METHOD

(71) Applicant: Panasonic Automotive Systems Co., Ltd., Kanagawa (JP)

(72) Inventors: Kazuya ARIMURA, Kanagawa (JP); Toshinari MORIKAWA, Kanagawa (JP); Masakazu NAKAZAWA, Osaka (JP)

(73) Assignee: Panasonic Automotive Systems Co., Ltd., Kanagawa (JP)

(21) Appl. No.: 18/985,762

(22) Filed: Dec. 18, 2024

(30) Foreign Application Priority Data
Dec. 25, 2023 (JP) 2023-218018

(51) Int. Cl. G06F 9/455; B60W 50/14; G06F 11/07; H04L 67/12

(52) U.S. Cl. CPC G06F 9/45558; B60W 50/14; G06F 11/0712; G06F 11/0739; H04L 67/12

(57) ABSTRACT

A vehicular device includes: a virtual machine (VM) that transmits information to a display; a hypervisor on which the VM runs; a monitor that monitors at least one of: presence or absence of an anomaly in the VM; or presence or absence of an anomaly in communication between the VM and the display; and a blocker that blocks the communication between the VM and the display when the monitor detects the anomaly in the VM or the anomaly in the communication between the VM and the display.

### CROSS REFERENCE TO RELATED APPLICATION

The present application is based on and claims priority of Japanese Patent Application No. 2023-218018 filed on Dec. 25, 2023.

### FIELD

The present disclosure relates to a vehicular device and a control method.

### BACKGROUND

A known vehicular device enables an operating system to cause a display included in a vehicle to display content (see Patent Literature (PTL) 1, for example). In the event of detection of anomalous content displayed on the display, this vehicular device causes shielding content to be superimposed upon this anomalous content on the display. Thus, the anomalous content that is hidden by the shielding content is displayed on the display.

### CITATION LIST

### Patent Literature

PTL 1: Japanese Unexamined Patent Application Publication No. 2020-187631

### SUMMARY

However, the conventional vehicular device described above can be improved upon.

In view of this, the present disclosure provides a vehicular device and a control method capable of improving upon the above related art.

In accordance with a first aspect of the present disclosure, a vehicular device provided to a vehicle including an output device for presenting information to a driver of the vehicle includes: an operating system that transmits the information to the output device; a virtual environment in which the operating system runs; a monitor that monitors at least one of: presence or absence of an anomaly in the operating system; or presence or absence of an anomaly in communication between the operating system and the output device; and a blocker that blocks the communication between the operating system and the output device when the monitor detects the anomaly in the operating system or the anomaly in the communication between the operating system and the output device.

General or specific aspects of the present disclosure may be implemented to a system, a method, an integrated circuit, a computer program, a computer-readable recording medium such as a Compact Disc-Read Only Memory (CD-ROM), or any given combination thereof.

A vehicular device according to one aspect of the present disclosure is capable of improving upon the above related art.

### BRIEF DESCRIPTION OF DRAWINGS

These and other advantages and features of the present disclosure will become apparent from the following description thereof taken in conjunction with the accompanying drawings that illustrate a specific embodiment of the present disclosure.

FIG. 1 is a block diagram illustrating a configuration of a vehicular device according to Embodiment 1.

FIG. 2 is a flowchart illustrating an operation performed by the vehicular device according to Embodiment 1.

FIG. 3 is a diagram illustrating examples displayed by a display according to Embodiment 1.

FIG. 4 is a diagram illustrating the operation performed by the vehicular device according to Embodiment 1.

FIG. 5 is a flowchart illustrating an operation performed by the vehicular device according to Embodiment 1.

FIG. 6 is a diagram illustrating examples of utterance outputted from a loudspeaker according to Embodiment 1.

FIG. 7 is a diagram illustrating the operation performed by the vehicular device according to Embodiment 1.

FIG. 8 is a block diagram illustrating a configuration of a vehicular device according to Embodiment 2.

FIG. 9 is a diagram illustrating an example of sensing information according to Embodiment 2.

FIG. 10 is a block diagram illustrating a configuration of a vehicular device according to Embodiment 3.

FIG. 11 is a diagram illustrating examples of utterance outputted from a loudspeaker according to Embodiment 3.

FIG. 12 is a block diagram illustrating a configuration of a vehicular device according to Embodiment 4.

FIG. 13 is a diagram illustrating examples displayed by a display according to Embodiment 4.

FIG. 14 is a block diagram illustrating a configuration of a vehicular device according to Embodiment 5.

### DESCRIPTION OF EMBODIMENTS

### Underlying Knowledge Forming Basis of the Present Disclosure

In relation to the technology in the Background section, the inventors have found the following issue.

The conventional vehicular device described above is able to respond to an anomalous output from an in-vehicle display-related output device (for example, anomalous content displayed on the display). However, the conventional vehicular device described above is unable to respond to an anomalous output from an output device other than the display-related output device, or more specifically, an anomalous output from an in-vehicle speech-related output device (for example, anomalous speech outputted from a loudspeaker).

In response to this issue, the inventors have found a vehicular device and a control method described below.

### (Technique 1)

A vehicular device provided to a vehicle including an output device for presenting information to a driver of the vehicle includes: an operating system that transmits the information to the output device; a virtual environment in which the operating system runs; a monitor that monitors at least one of: presence or absence of an anomaly in the operating system; or presence or absence of an anomaly in communication between the operating system and the output device; and a blocker that blocks the communication between the operating system and the output device when the monitor detects the anomaly in the operating system or the anomaly in the communication between the operating system and the output device.

With technology 1, when the monitor detects the anomaly in the operating system or the anomaly in the communication between the operating system and the output device, the blocker blocks the communication between the operating system and the output device. This keeps the anomalous information from being transmitted from the operating system to the output device. Thus, this enables the vehicular device to respond to an anomalous output from any output device, such as a display-related device or a speech-related device.

### (Technique 2)

In the vehicular device according to technique 1, the vehicle further includes an in-vehicle network including a sensor that performs sensing on the vehicle or a surrounding environment of the vehicle, the in-vehicle network being a network that transmits, to the operating system via the virtual environment, sensing information indicating a result of the sensing performed by the sensor, and the operating system obtains the sensing information from the in-vehicle network and generates the information based on the sensing information obtained.

With technology 2, the operating system is able to easily generate the information on the vehicle, based on the sensing information obtained from the in-vehicle network.

### (Technique 3)

In the vehicular device according to technique 2, the monitor further monitors at least one of: presence or absence of an anomaly in the in-vehicle network; or presence or absence of an anomaly in communication between the operating system and the in-vehicle network, and the blocker further blocks the communication between the operating system and the in-vehicle network when the monitor detects the anomaly in the in-vehicle network or the anomaly in the communication between the operating system and the in-vehicle network.

With technology 3, when the monitor detects the anomaly in the in-vehicle network or the anomaly in the communication between the operating system and the in-vehicle network, the blocker blocks the communication between the operating system and the in-vehicle network. This keeps the anomalous information from being transmitted from the in-vehicle network to the operating system.

### (Technique 4)

The vehicular device according to technique 3, further includes: a substituter that, when the blocker blocks the communication between the operating system and the in-vehicle network, generates substitutive sensing information that substitutes for the sensing information and then transmits, to the operating system, the substitutive sensing information generated, wherein the operating system generates the information based on the substitutive sensing information received from the substituter.

With technology 4, even when the blocker blocks the communication between the operating system and the in-vehicle network, the operating system is able to transmit, to the output device, the information generated based on the substitutive sensing information received from the substituter. This enables the output device to present appropriate information.

### (Technique 5)

The vehicular device according to technique 2 or 3, further includes: a substituter that, when the blocker blocks the communication between the operating system and the output device, generates, based on the sensing information received from the in-vehicle network, substitutive information that substitutes for the information and then transmits, to the output device, the substitutive information generated.

With technology 5, even when the blocker blocks the communication between the operating system and the output device, the substituter is able to transmit the substitutive information to the output device. This enables the output device to present appropriate information.

### (Technique 6)

In the vehicular device according to any one of techniques 1 to 5, the monitor and the blocker run in the virtual environment.

With technology 6, the monitor runs in the virtual environment and thus is able to easily monitor the presence or absence of an anomaly in the communication between the operating system and the output device. Furthermore, the blocker runs in the virtual environment and thus is able to easily block the communication between the operating system and the output device.

### (Technique 7)

The vehicular device according to any one of techniques 1to 5 further includes: a management operating system that runs in the virtual environment, wherein the monitor and the blocker run on the management operating system.

With technology 7, the monitor runs on the management operating system. Thus, through the transfer of a part of the function of the virtual environment to the management operating system, the monitor is able to easily monitor the presence or absence of an anomaly in the communication between the operating system and the output device. Furthermore, the blocker runs on the management operating system. Thus, through the transfer of a part of the function of the virtual environment to the management operating system, the blocker is able to easily block the communication between the operating system and the output device.

### (Technique 8)

A control method is used by a vehicular device provided to a vehicle including an output device for presenting information to a driver of the vehicle. The vehicular device includes an operating system and a virtual environment in which the operating system runs. The control method includes: (a) transmitting the information from the operating system to the output device; (b) monitoring at least one of: presence or absence of an anomaly in the operating system;

or presence or absence of an anomaly in communication between the operating system and the output device; and (c) blocking the communication between the operating system and the output device when the anomaly in the operating system or the anomaly in the communication between the operating system and the output device is detected in (b).

With technology 8, when the anomaly in the operating system or the anomaly in the communication between the operating system and the output device is detected, the communication between the operating system and the output device is blocked. This keeps the anomalous information from being transmitted from the operating system to the output device. Thus, this enables the vehicular device to respond to an anomalous output from any output device, such as a display-related device or a speech-related device.

General or specific aspects of the present disclosure may be implemented to a system, a method, an integrated circuit, a computer program, a computer-readable recording medium such as a Compact Disc-Read Only Memory (CD-ROM), or any given combination thereof.

Hereinafter, certain exemplary embodiments will be described in detail with reference to the accompanying Drawings.

The following embodiments are general or specific examples of the present disclosure. The numerical values, shapes, materials, elements, arrangement and connection configuration of the elements, steps, the order of the steps, etc., described in the following embodiments are merely examples, and are not intended to limit the present disclosure. Among elements in the following embodiments, those not described in any one of the independent claims indicating the broadest concept of the present disclosure are described as optional elements.

### EMBODIMENT 1

### 1. Configuration of Vehicular Device

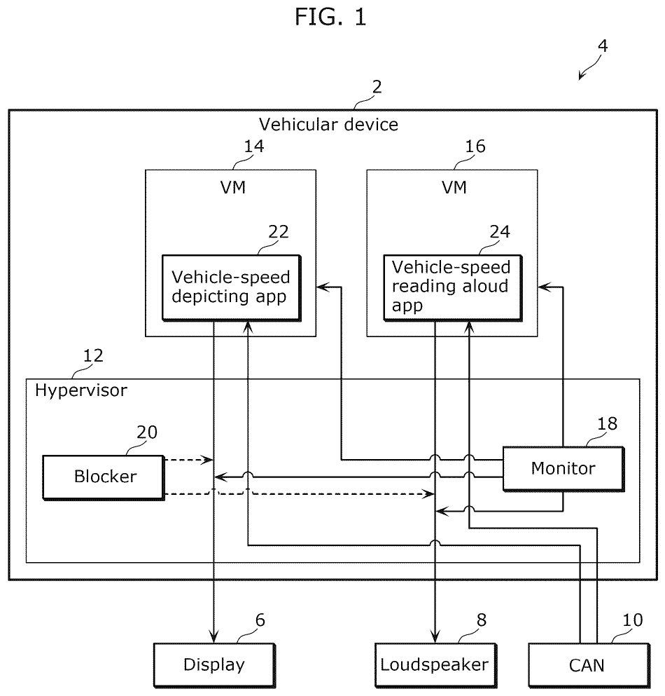

A configuration of vehicular device 2 according to Embodiment 1 is described with reference to FIG. 1. FIG. 1 is a block diagram illustrating the configuration of vehicular device 2 according to Embodiment 1.

As illustrated in FIG. 1, vehicular device 2 according to Embodiment 1 is included in vehicle 4 that is an automobile for example. Vehicle 4 includes display 6, loudspeaker 8, and controller area network (CAN) 10.

Display 6 is an example of a display-related output device for presenting information using an image to a driver of vehicle 4. Display 6 may be a meter display, a center display, or a head-up display. Display 6 receives information from vehicular device 2 and displays an image depicting, for example, a vehicle speed indicated by the received information.

Loudspeaker 8 is an example of a speech-related output device for presenting information by speech to the driver of vehicle 4. Loudspeaker 8 may be disposed in the dashboard of vehicle 4 or in a front door of vehicle 4. Loudspeaker 8 receives information from vehicular device 2 and outputs mechanical speech that reads aloud, for example, a vehicle speed indicated by the received information.

CAN 10 is an example of an in-vehicle network included in vehicle 4. For example, CAN 10 is an in-vehicle network that establishes communications according to a CAN protocol. CAN 10 includes a CAN bus and a sensor that is connected to the CAN bus. The sensor is an example of a sensor that performs sensing on vehicle 4 and a surrounding environment of vehicle 4. For example, the sensor is a vehicle speed sensor that senses the vehicle speed (that is, the traveling speed of vehicle 4). CAN 10 transmits, to vehicular device 2, sensing information indicating the sensing result on the vehicle speed obtained by the sensor.

Vehicular device 2 includes hypervisor 12, virtual machine (VM) 14, VM 16, monitor 18, and blocker 20. Note that monitor 18 and blocker 20 make up a monitoring system. As described later, monitor 18 and blocker 20 run on hypervisor 12. This means that the monitoring system is included in hypervisor 12.

Hypervisor 12 is an example of a virtual environment in which VM 14 and VM 16 run. For example, hypervisor 12 is virtual software executed on hardware (not shown), such as a central processing unit (CPU) or an electronic control unit (ECU). Hypervisor 12 enables the different virtual machines, VM 14 and VM 16, to run on a single piece of hardware. In the present embodiment, hypervisor 12 is a so-called bare metal hypervisor (Type 1). Note that hypervisor 12 may be a so-called hosted hypervisor (Type 2) that runs on an operating system.

Hypervisor 12 relays communication between CAN 10 and VM 14 and communication between CAN 10 and VM 16. To be more specific, hypervisor 12 receives sensing information from CAN 10 and transmits the received sensing information to VM 14 and VM 16. Moreover, hypervisor 12 relays communication between VM 14 and display 6. To be more specific, hypervisor 12 receives, from VM 14, information indicating an image depicting the vehicle speed, and then transmits the received information to display 6. Furthermore, hypervisor 12 relays communication between VM 16 and loudspeaker 8. To be more specific, hypervisor 12 receives, from VM 16, information indicating mechanical speech that reads aloud the vehicle speed, and then transmits the received information to loudspeaker 8.

VM 14 is an example of an operating system that runs on hypervisor 12. For example, VM 14 is a virtual machine, such as Linux (registered trademark). VM 14 is equipped with vehicle-speed depicting app 22 that is application software (hereafter, also simply referred to as an app) for generating an image depicting the vehicle speed. Vehicle-speed depicting app 22 obtains the sensing information indicating the sensing result on the vehicle speed, from CAN 10 via hypervisor 12. Then, based on the obtained sensing information, vehicle-speed drawing app 22 generates information indicating an image depicting the vehicle speed. Moreover, vehicle-speed depicting app 22 transmits the generated information to display 6 via hypervisor 12.

VM 16 is an example of the operating system that runs on hypervisor 12. For example, VM 16 is a virtual machine, such as Linux (registered trademark). VM 16 is equipped with vehicle-speed reading aloud app 24 that is application software for generating mechanical speech that reads aloud the vehicle speed. Vehicle-speed reading aloud app 24 obtains the sensing information indicating the sensing result on the vehicle speed, from CAN 10 via hypervisor 12. Then, based on the obtained sensing information, vehicle-speed reading aloud app 24 generates information indicating mechanical speech that reads aloud the vehicle speed. Moreover, vehicle-speed reading aloud app 24 transmits the generated information to loudspeaker 8 via hypervisor 12.

Monitor 18 runs on hypervisor 12. Monitor 18 obtains a state of VM 14 from VM 14. Based on the obtained state of VM 14, monitor 18 monitors the presence or absence of an anomaly in VM 14. Here, examples of “anomaly in VM 14” include: (a) an operation anomaly of vehicle-speed depicting app 22 of VM 14; (b) an operation anomaly of an app other than vehicle-speed depicting app 22 of VM 14 (such as a timer app having a timer function); and (c) an operation anomaly of VM 14 itself as the operating system.

Furthermore, monitor 18 obtains content of communication between VM 14 and display 6. Based on the obtained content of communication, monitor 18 monitors the presence or absence of an anomaly in the communication between VM 14 and display 6. Here, “anomaly in the communication between VM 14 and display 6” refers to an anomaly in the content of communication between VM 14 (for example, an app like vehicle-speed depicting app 22 of VM 14) and display 6.

Furthermore, monitor 18 obtains a state of VM 16 from VM 16. Then, based on the obtained state of VM 16, monitor 18 monitors the presence or absence of an anomaly in VM 16. Here, examples of “anomaly in VM 16” include: (a) an operation anomaly of vehicle-speed reading aloud app 24 of VM 16; (b) an operation anomaly of an app other than vehicle-speed reading aloud app 24 of VM 16 (such as a timer app); and (c) an operation anomaly of VM 16 itself as the operating system.

Furthermore, monitor 18 obtains content of communication between VM 16 and loudspeaker 8. Then, based on the obtained content of communication, monitor 18 monitors the presence or absence of an anomaly in the communication between VM 16 and loudspeaker 8. Here, “anomaly in the communication between VM 16 and loudspeaker 8” refers to an anomaly in the content of communication between VM 16 (for example, an app like vehicle-speed reading aloud app 24 of VM 16) and loudspeaker 8.

Monitor 18 asynchronously monitors (a) the presence or absence of an anomaly in VM 14, (b) the presence or absence of an anomaly in the communication between VM 14 and display 6, (c) the presence or absence of an anomaly in VM 16, and (d) the presence or absence of an anomaly in the communication between VM 16 and loudspeaker 8 that are described above. Note that monitor 18 may simultaneously monitor the aforementioned (a) to (d) each describing the presence or absence of a corresponding anomaly. Furthermore, monitor 18 may monitor at least one of the aforementioned (a) to (d) each describing the presence or absence of a corresponding anomaly.

When detecting any one of (a) anomaly in VM 14, (b) anomaly in the communication between VM 14 and display 6, (c) anomaly in VM 16, or (d) anomaly in the communication between VM 16 and loudspeaker 8, monitor 18 outputs the detection result to blocker 20.

Blocker 20 runs on hypervisor 12. Based on the detection result from monitor 18, blocker 20 blocks the communication between VM 14 and display 6. To be more specific, when monitor 18 detects an anomaly in VM 14 or an anomaly in the communication between VM 14 and display 6, blocker 20 blocks the communication between VM 14 (for example, an app like vehicle-speed depicting app 22 of VM 14) and display 6. For example, when monitor 18 detects an operation anomaly of vehicle-speed depicting app 22, blocker 20 blocks the communication between vehicle-speed depicting app 22 and display 6. For example, when monitor 18 detects an operation anomaly of the timer app, blocker 20 blocks the communication between vehicle-speed depicting app 22 and display 6 or the communication between the timer app and display 6.

Furthermore, based on the detection result from monitor 18, blocker 20 blocks the communication between VM 16 and loudspeaker 8. To be more specific, when monitor 18 detects an anomaly in VM 16 or an anomaly in the communication between VM 16 and loudspeaker 8, blocker 20 blocks the communication between VM 16 (for example, an app like vehicle-speed reading aloud app 24 of VM 16) and loudspeaker 8. For example, when monitor 18 detects an operation anomaly of vehicle-speed reading aloud app 24, blocker 20 blocks the communication between vehicle-speed reading aloud app 24 and loudspeaker 8. For example, when monitor 18 detects an operation anomaly of the timer app, blocker 20 blocks the communication between vehicle-speed reading aloud app 24 and loudspeaker 8 or the communication between the timer app and loudspeaker 8.

### 2. Operation of Vehicular Device

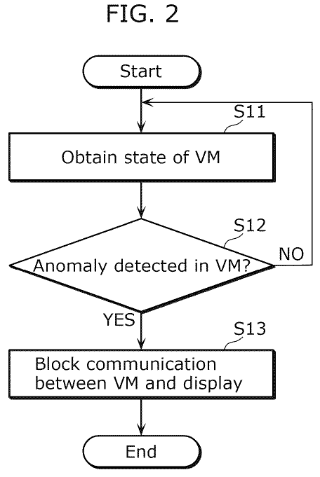

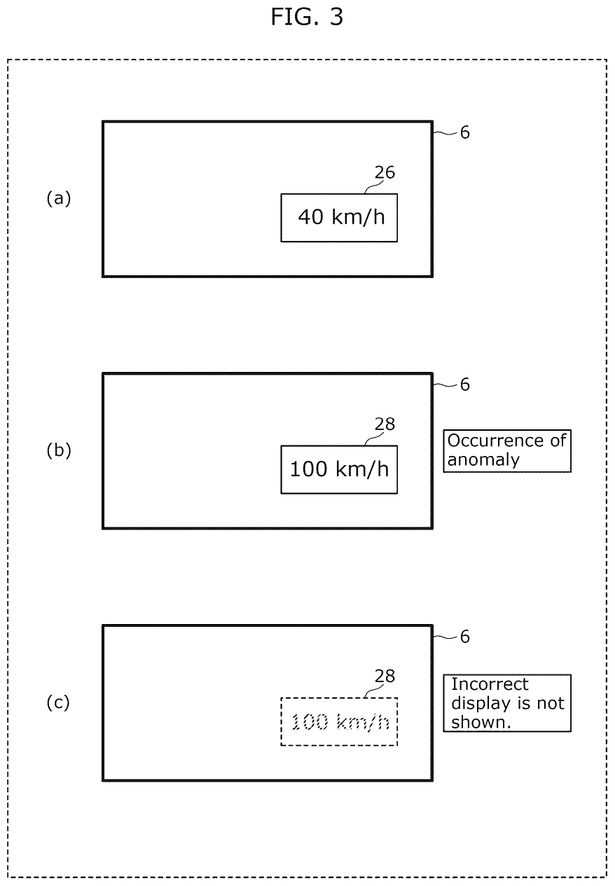

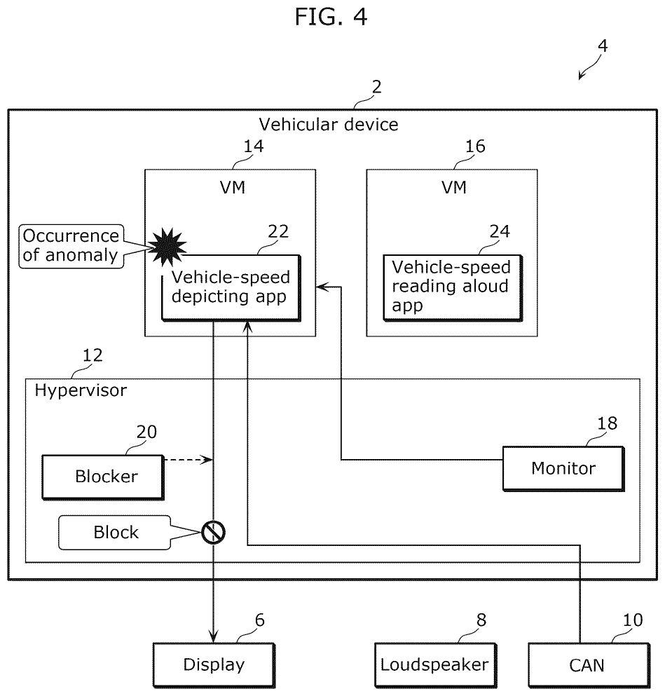

An operation performed by vehicular device 2 according to Embodiment 1 when monitor 18 detects an anomaly in VM 14 is described with reference to FIG. 2 to FIG. 4. FIG. 2 is a flowchart illustrating the operation performed by vehicular device 2 according to Embodiment 1. FIG. 3 is a diagram illustrating examples displayed by display 6 according to Embodiment 1. FIG. 4 is a diagram illustrating the operation performed by vehicular device 2 according to Embodiment 1.

As illustrated in FIG. 2, monitor 18 obtains the state of VM 14 from VM 14 (S11). Based on the obtained state of VM 14, monitor 18 monitors the presence or absence of an anomaly in VM 14. When monitor 18 detects no anomaly in VM 14 (NO in S12), the processing returns to Step S11.

In this case, when vehicle 4 is traveling at a vehicle speed of “40 km/h”, vehicle-speed depicting app 22 of VM 14 generates, based on the sensing information received from CAN 10, information indicating an image depicting the vehicle speed of “40 km/h”. Then, vehicle-speed depicting app 22 transmits the generated information to display 6. As a result, display 6 displays image 26 depicting the vehicle speed of “40 km/h”, as illustrated in (a) of FIG. 3.

As illustrated in FIG. 4, when detecting an anomaly in VM 14 (YES in S12), monitor 18 outputs the detection result to blocker 20. Based on the detection result from monitor 18, blocker 20 blocks the communication between VM 14 and display 6 (S13).

In the event of an anomaly occurring to VM 14, display 6 displays image 28 depicting an incorrect vehicle speed of “100 km/h” that is different from the actual vehicle speed of “40 km/h” for example, as illustrated in (b) of FIG. 3. More specifically, an anomalous output is displayed by display 6. In this case, blocker 20 blocks the communication between VM 14 and display 6. This disables display 6 from receiving the information from vehicle-speed depicting app 22 of VM 14. As a result, image 28 depicting the incorrect vehicle speed of “100 km/h” is no longer displayed on display 6, as illustrated in (c) of FIG. 3. Note that, at this time, display 6 may display text saying “The displayed vehicle speed is anomalous” for instance to notify the driver about the occurrence of the anomalous display of the vehicle speed. Alternatively, at this time, loudspeaker 8 may output mechanical speech having utterance content saying “The displayed vehicle speed is anomalous” for instance to notify the driver about the occurrence of the anomalous display of the vehicle speed.

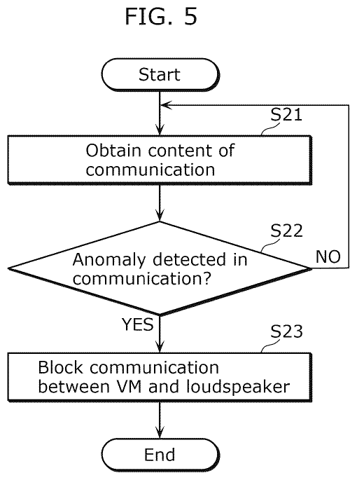

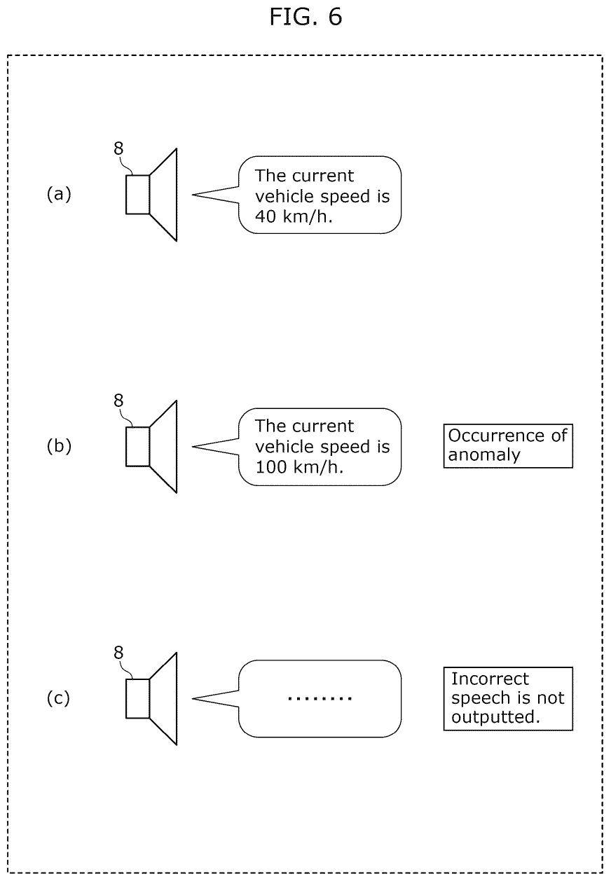

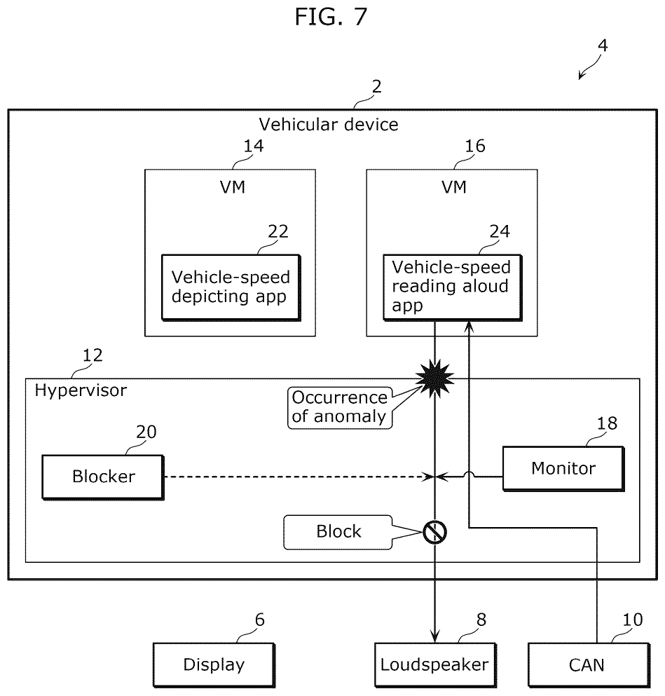

Next, an operation performed by vehicular device 2 according to Embodiment 1 when monitor 18 detects an anomaly in the communication between VM 16 and loudspeaker 8 is described with reference to FIG. 5 to FIG. 7. FIG. 5 is a flowchart illustrating the operation performed by vehicular device 2 according to Embodiment 1. FIG. 6 is a diagram illustrating examples of utterance outputted from loudspeaker 8 according to Embodiment 1. FIG. 7 is a diagram illustrating the operation performed by vehicular device 2 according to Embodiment 1.

As illustrated in FIG. 5, monitor 18 obtains the content of communication between VM 16 and loudspeaker 8 (S21). Based on the obtained content of communication, monitor 18 monitors the presence or absence of an anomaly in the communication between VM 16 and loudspeaker 8. When monitor 18 detects no anomaly in the communication between VM 16 and loudspeaker 8 (NO in S22), the processing returns to Step S21. In this case, when vehicle 4 is traveling at a vehicle speed of “40 km/h”, vehicle-speed reading aloud app 24 of VM 16 generates, based on the sensing information received from CAN 10, information indicating mechanical speech that reads aloud utterance content saying “The current vehicle speed is 40 km/h”. Then, vehicle-speed reading aloud app 24 transmits the generated information to loudspeaker 8. As a result, loudspeaker 8 outputs the mechanical speech that reads aloud the utterance content saying “The current vehicle speed is 40 km/h”, as illustrated in (a) of FIG. 6.

As illustrated in FIG. 7, when detecting an anomaly in the communication between VM 16 and loudspeaker 8 (YES in S22), monitor 18 outputs the detection result to blocker 20. Based on the detection result from monitor r 18, blocker 20 blocks the communication between VM 16 and loudspeaker 8 (S23).

In the event of an anomaly occurring to the communication between VM 16 and loudspeaker 8, loudspeaker 8 outputs mechanical speech that reads aloud utterance content saying “The current vehicle speed is 100 km/h” indicating an incorrect vehicle speed that is different from the utterance content saying “The current vehicle speed is 40 km/h” indicating the actual vehicle speed for example, as illustrated in (b) of FIG. 6. In this case, blocker 20 blocks the communication between VM 16 and loudspeaker 8. This disables loudspeaker 8 from receiving the information from vehicle-speed reading aloud app 24 of VM 16. As a result, the mechanical speech that reads aloud the utterance content saying “The current vehicle speed is 100 km/h” indicating the incorrect vehicle speed is no longer outputted, as illustrated in (c) of FIG. 6. Note that, at this time, loudspeaker 8 may output mechanical speech that reads aloud utterance content saying “The speech is anomalous” for instance to notify the driver about the occurrence of the anomalous speech. Alternatively, at this time, display 6 may display text saying “The speech is anomalous” for instance to notify the driver about the occurrence of the anomalous speech.

The above description on the flowchart in FIG. 2 can be turned into the description on an operation performed by vehicular device 2 according to Embodiment 1 when monitor 18 detects an anomaly in VM 16. For this purpose, the terms “VM 14” and “display 6” in Steps S11 to S13 in the flowchart of FIG. 2 may be replaced with the terms “VM 16” and “loudspeaker 8”, respectively.

The above description on the flowchart of FIG. 5 can be turned into the description on an operation performed by vehicular device 2 according to Embodiment 1 when monitor 18 detects an anomaly in the communication between VM 14 and display 6. For this purpose, the terms “VM 16” and “loudspeaker 8” in Steps S21 to S23 in the flowchart of FIG. 5 may be replaced with the terms “VM 14” and “display 6”, respectively.

### 3. Advantageous Effects

According to the present embodiment described above, when monitor 18 detects an anomaly in VM 14 or an anomaly in the communication between VM 14 and display 6, blocker 20 blocks the communication between VM 14 and display 6. Furthermore, when monitor 18 detects an anomaly in VM 16 or an anomaly in the communication between VM 16 and loudspeaker 8, blocker 20 blocks the communication between VM 16 and loudspeaker 8.

With this, vehicular device 2 is able to respond to an anomalous output from a corresponding output device included in vehicle 4, such as display 6 that is the display-related output device or loudspeaker 8 that is the speech-related output device.

### EMBODIMENT 2

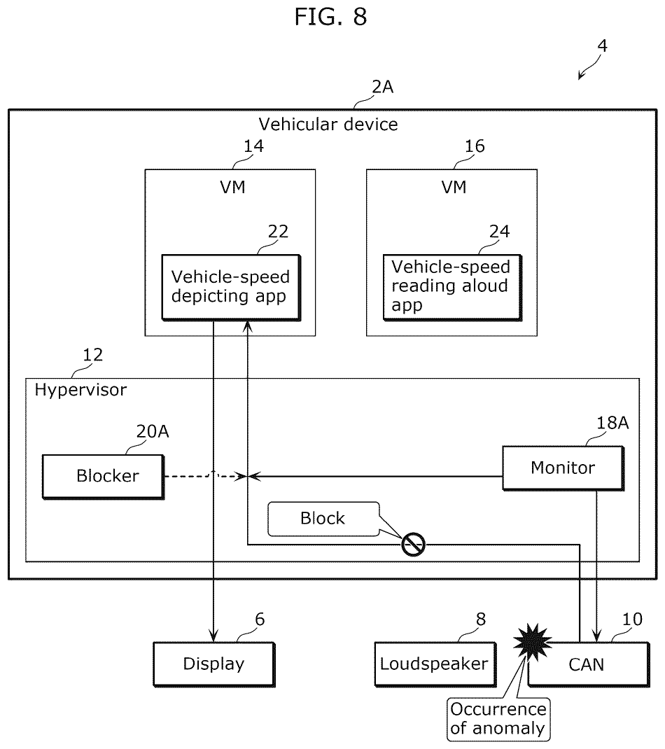

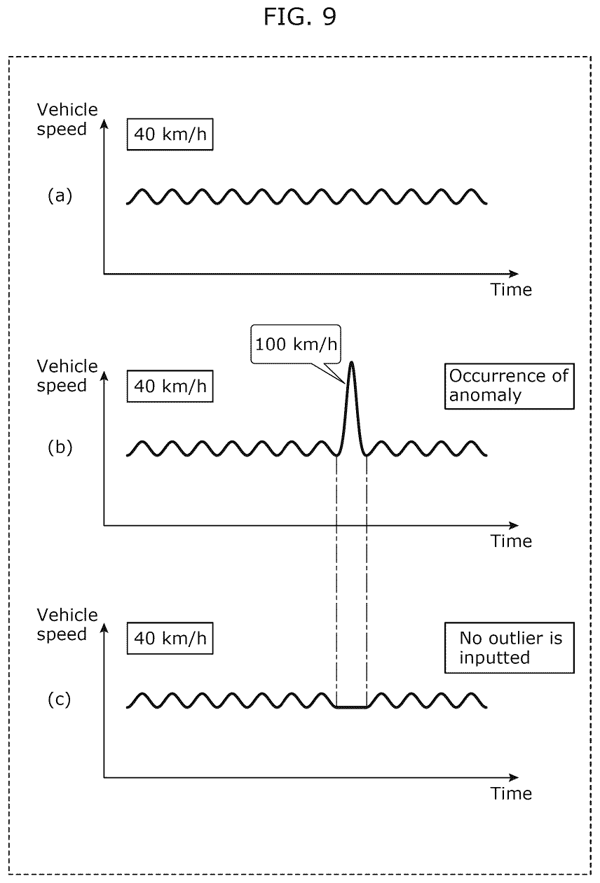

A configuration of vehicular device 2A according to Embodiment 2 is described with reference to FIG. 8 and FIG. 9. FIG. 8 is a block diagram illustrating the configuration of vehicular device 2 according to Embodiment 2. FIG. 9 is a diagram illustrating an example of sensing information according to Embodiment 2. Note that structural components in the present embodiment that are identical to those in Embodiment 1 described above are assigned reference marks identical to those used in Embodiment 1, and thus descriptions of these structural components are omitted from the present embodiment.

As illustrated in FIG. 8, vehicular device 2A according to Embodiment 2 includes monitor 18A and blocker 20A that have functions different from the functions of monitor 18 and blocker 20 according to Embodiment 1 described above.

To be more specific, monitor 18A has the following function in addition to the function described above in Embodiment 1. Monitor 18A obtains a state of CAN 10 from CAN 10. Then, based on the obtained state of CAN 10, monitor 18A monitors the presence or absence of an anomaly in CAN 10. Here, “anomaly in CAN 10” refers to an operation anomaly of, for example, a sensor of CAN 10. Furthermore, monitor 18A obtains content of communication between VM 14 and CAN 10. Then, based on the obtained content of communication, monitor 18A monitors the presence or absence of an anomaly in the communication between VM 14 and CAN 10. Here, “anomaly in the communication between VM 14 and CAN 10” refers to an anomaly in the content of communication between VM 14 (for example, an app like vehicle-speed depicting app 22 of VM 14) and CAN 10.

Furthermore, monitor 18A obtains content of communication between VM 16 and CAN 10. Then, based on the obtained content of communication, monitor 18A monitors the presence or absence of an anomaly in the communication between VM 16 and CAN 10. Here, “anomaly in the communication between VM 16 and CAN 10” refers to an anomaly in the content of communication between VM 16 (for example, an app like vehicle-speed reading aloud app 24 of VM 16) and CAN 10.

When detecting any one of (a) anomaly in CAN 10, (b) anomaly in the communication between VM 14 and CAN 10, or (c) anomaly in the communication between VM 16 and CAN 10, monitor 18A outputs the detection result to blocker 20A.

Blocker 20A has the following function in addition to the function described above in Embodiment 1. Based on the detection result obtained from monitor 18A, blocker 20A blocks the communication between VM 14 and CAN 10. To be more specific, as illustrated in FIG. 8, when monitor 18A detects the anomaly in CAN 10 or an anomaly in the communication between VM 14 and CAN 10, blocker 20A blocks the communication between VM 14 (for example, an app like vehicle-speed depicting app 22 of VM 14) and CAN 10.

Furthermore, based on the detection result obtained from monitor 18A, blocker 20A blocks the communication between VM 16 and CAN 10. To be more specific, although not shown, when monitor 18A detects the anomaly in CAN 10 or an anomaly in the communication between VM 16 and CAN 10, blocker 20A blocks the communication between VM 16 (for example, an app like vehicle-speed reading aloud app 24 of VM 16) and CAN 10.

When vehicle 4 is traveling at a substantially constant speed of “40 km/h” for example, CAN 10 transmits sensing information indicating the vehicle speed of “40 km/h” to VM 14 and VM 16 as illustrated in (a) of FIG. 9. In the event of an anomaly occurring to CAN 10 for example, CAN 10 transmits sensing information indicating a vehicle speed of “100 km/h” that is an outlier to VM 14 and VM 16 as illustrated in (b) of FIG. 9. In this case, blocker 20A blocks the communication between VM 14 and CAN 10 and the communication between VM 16 and CAN 10. This disables CAN 10 from transmitting the sensing information indicating the vehicle speed of “100 km/h” that is the outlier to VM 14 and VM 16 as illustrated in (c) of FIG. 9.

Thus, according to the present embodiment, when monitor 18A detects any one of (a) anomaly in CAN 10, (b) anomaly in the communication between VM 14 and CAN 10, or (c) anomaly in the communication between VM 16 and CAN 10, the anomalous sensing information is kept from being transmitted from CAN 10 to VM 14 and VM 16.

### EMBODIMENT 3

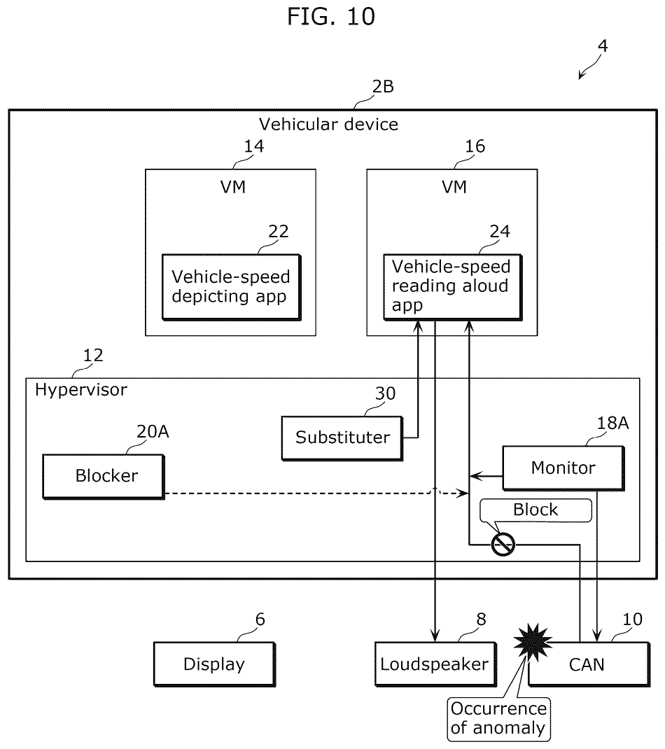

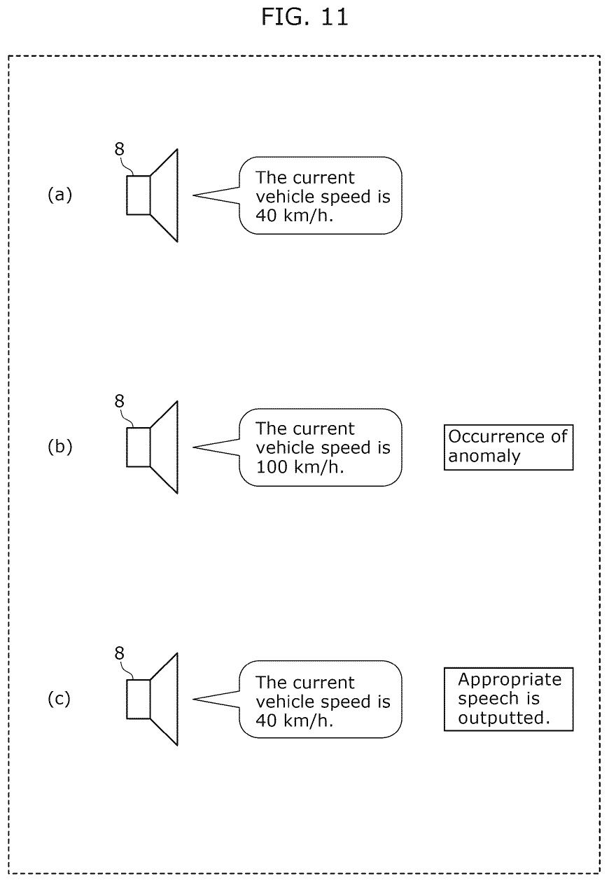

A configuration of vehicular device 2B according to Embodiment 3 is described with reference to FIG. 10 and FIG. 11. FIG. 10 is a block diagram illustrating the configuration of vehicular device 2B according to Embodiment 3. FIG. 11 is a diagram illustrating examples of utterance outputted from loudspeaker 8 according to Embodiment 3. Note that structural components in the present embodiment that are identical to those in Embodiment 2 described above are assigned reference marks identical to those used in Embodiment 2, and thus descriptions of these structural components are omitted from the present embodiment.

As illustrated in FIG. 10, vehicular device 2B according to Embodiment 3 includes substituter 30 in addition to the structural components described above in Embodiment 2. Substituter 30 runs on hypervisor 12, for example.

As illustrated in FIG. 10, when blocker 20A blocks the communication between VM 16 and CAN 10, substituter 30 generates substitutive sensing information that substitutes for the sensing information from CAN 10.

At this time, substituter 30 learns the sensing information previously transmitted from CAN 10 for example. Then, substituter 30 predicts current sensing information and generates, based on the predicted current sensing information, the substitutive sensing information. Alternatively, in the event of an anomaly occurring to a vehicle speed sensor included in CAN 10, substituter 30 may generate the substitutive sensing information based on sensing information obtained from a sensor other than the vehicle speed sensor (such as a camera sensor that captures an image of the outside of vehicle 4).

Then, substituter 30 transmits the generated substitutive sensing information to VM 16. This allows vehicle-speed reading aloud app 24 of VM 16 to generate, based on the substitutive sensing information received from substituter 30, information indicating mechanical speech that reads aloud the vehicle speed.

When vehicle 4 is traveling at a vehicle speed of “40 km/h” for example, vehicle-speed reading aloud app 24 of VM 16 generates, based on the sensing information received from CAN 10, information indicating mechanical speech that reads aloud utterance content saying “The current vehicle speed is 40 km/h”. Then, vehicle-speed reading aloud app 24 transmits the generated information to loudspeaker 8. As a result, loudspeaker 8 outputs the mechanical speech that reads aloud the utterance content saying “The current vehicle speed is 40 km/h”, as illustrated in (a) of FIG. 11. In the event of an anomaly occurring to CAN 10 for example, loudspeaker 8 outputs mechanical speech that reads aloud utterance content saying “The current vehicle speed is 100 km/h” indicating an incorrect vehicle speed that is different from the utterance content saying “The current vehicle speed is 40 km/h” indicating the actual vehicle speed for example, as illustrated in (b) of FIG. 11.

In this case, blocker 20 blocks the communication between VM 16 and CAN 10, and also substituter 30 transmits the substitutive sensing information to VM 16. This allows loudspeaker 8 to output the mechanical speech that reads aloud the utterance content saying “The current vehicle speed is 40 km/h” indicating an appropriate vehicle speed, as illustrated in (c) of FIG. 11.

Furthermore, although not shown, when blocker 20A blocks the communication between VM 14 and CAN 10, substituter 30 generates substitutive sensing information that substitutes for the sensing information from CAN 10. Then, substituter 30 transmits the generated substitutive sensing information to VM 14. This allows VM 14 to generate, based on the substitutive sensing information received from substituter 30, information indicating an image depicting the vehicle speed.

Thus, according to the present embodiment, when monitor 18A detects any one of (a) anomaly in CAN 10, (b) anomaly in the communication between VM 14 and CAN 10, or (c) anomaly in the communication between VM 16 and CAN 10, the anomalous sensing information is kept from being transmitted from CAN 10 to VM 14 and VM 16 and also appropriate information is presented by display 6 and loudspeaker 8.

### EMBODIMENT 4

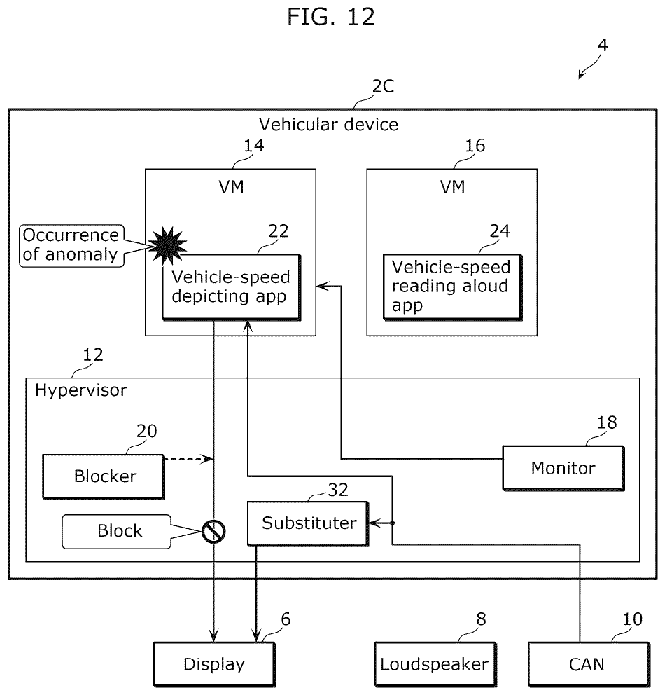

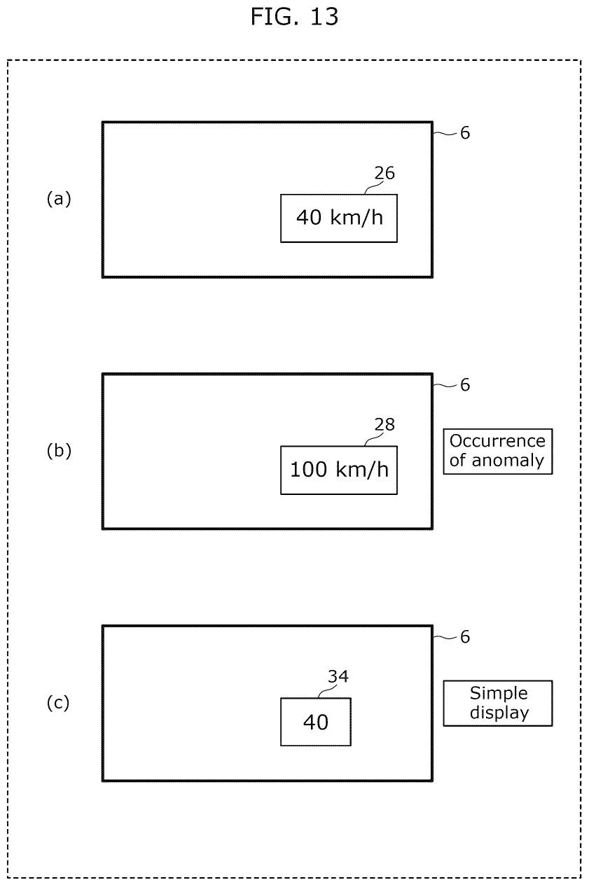

A configuration of vehicular device 2C according to Embodiment 4 is described with reference to FIG. 12 and FIG. 13. FIG. 12 is a block diagram illustrating the configuration of vehicular device 2C according to Embodiment 4. FIG. 13 is a diagram illustrating examples displayed by display 6 according to Embodiment 4. Note that structural components in the present embodiment that are identical to those in Embodiment 1 described above are assigned reference marks identical to those used in Embodiment 1, and thus descriptions of these structural components are omitted from the present embodiment.

As illustrated in FIG. 12, vehicular device 2C according to Embodiment 4 includes substituter 32 in addition to the structural components described above in Embodiment 1. Substituter 32 runs on hypervisor 12, for example.

As illustrated in FIG. 12, when blocker 20 blocks the communication between VM 14 and display 6, substituter 32 generates, based on the sensing information received from CAN 10, substitutive information that substitutes for the information indicating the image depicting the vehicle speed received from VM 14.

The substitutive information indicates an image simply depicting the vehicle speed, for example. Then, substituter 32 transmits the generated substitutive information to display 6. This allows display 6 to display, based on the substitutive information received from substituter 32, the image simply depicting the vehicle speed.

When vehicle 4 is traveling at a vehicle speed of “40 km/h” for example, vehicle-speed depicting app 22 of VM 14 generates, based on the sensing information received from CAN 10, information indicating an image depicting the vehicle speed of “40 km/h”. Then, vehicle-speed depicting app 22 transmits the generated information to display 6. As a result, display 6 displays image 26 depicting the vehicle speed of “40 km/h”, as illustrated in (a) of FIG. 13.

In the event of an anomaly occurring to VM 14 for example, display 6 displays image 28 depicting an incorrect vehicle speed of “100 km/h” that is different from the actual vehicle speed of “40 km/h” for example, as illustrated in (b) of FIG. 13. In this case, blocker 20 blocks the communication between VM 14 and display 6, and also substituter 32 transmits the substitutive information to display 6. This allows display 6 to display image 34 simply depicting the vehicle speed, as illustrated in (c) of FIG. 13. Image 34 indicates only a numerical value, such as “40”, corresponding to the vehicle speed without a measurement unit of speed.

Furthermore, although not shown, when blocker 20 blocks the communication between VM 16 and loudspeaker 8, substituter 32 generates, based on the sensing information received from CAN 10, substitutive information that substitutes for the information indicating the mechanical speech that reads aloud the vehicle speed transmitted from VM 16. The substitutive information indicates mechanical speech that simply reads aloud the vehicle speed, for example. Then, substituter 32 transmits the generated substitutive information to loudspeaker 8. This allows loudspeaker 8 to output, based on the substitutive information received from substituter 32, the mechanical speech that simply reads aloud the vehicle speed.

Thus, according to the present embodiment, when monitor 18 detects any one of (a) anomaly in VM 14, (b) anomaly in the communication between VM 14 and display 6, (c) anomaly in VM 16, or (d) anomaly in the communication between VM 16 and loudspeaker 8, appropriate information is presented by display 6 and loudspeaker 8.

### EMBODIMENT 5

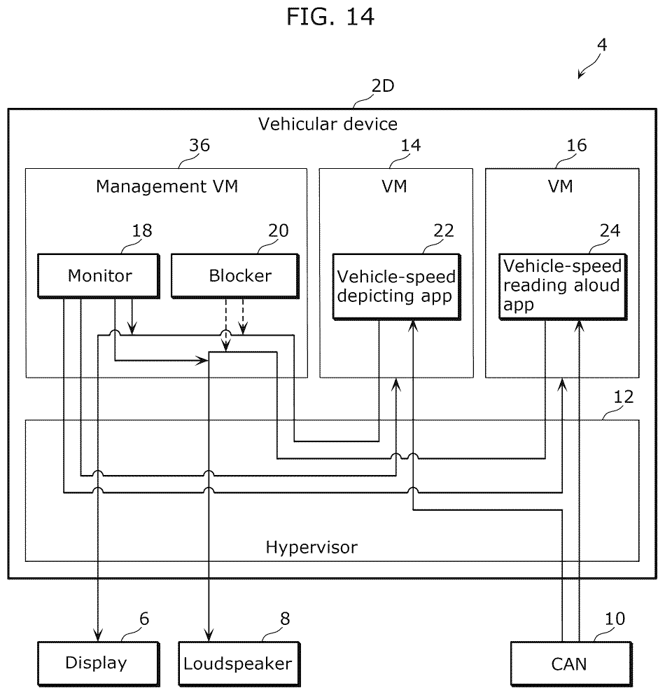

A configuration of vehicular device 2D according to Embodiment 5 is described with reference to FIG. 14. FIG. 14 is a block diagram illustrating the configuration of vehicular device 2D according to Embodiment 5. Note that structural components in the present embodiment that are identical to those in Embodiment 1 described above are assigned reference marks identical to those used in Embodiment 1, and thus descriptions of these structural components are omitted from the present embodiment.

As illustrated in FIG. 14, vehicular device 2D according to Embodiment 5 includes management VM 36 in addition to the structural components described above in Embodiment 1. Management VM 36 is an example of a management operating system that runs on hypervisor 12. For example, management VM 36 is a virtual machine, such as Linux (registered trademark).

Furthermore, management VM 36 has a part of the function of hypervisor 12, or more specifically, a function of relaying communication between VM 14 and display 6 and communication between VM 16 and loudspeaker 8.

Monitor 18 and blocker 20 of vehicular device 2D according to Embodiment 5 run on management VM 36. To be more specific, in the present embodiment, a monitoring system including monitor 18 and blocker 20 is included in management VM 36. As described above, management VM 36 has a part of the function of hypervisor 12. Thus, management VM 36 is able to obtain content of communication between VM 14 and display 6 and content of communication between VM 16 and loudspeaker 8.

Thus, the configuration according to the present embodiment can also achieve the same advantageous effects as those achieved in Embodiment 1. Note that vehicular device 2D may also include substituter 30 described above in Embodiment 3 or substituter 32 described above in Embodiment 4. In this case, substituter 30 or substituter 32 may run on management VM 36.

### OTHER EMBODIMENTS

Although the vehicular device and the like according to one or more aspects of the present disclosure have been described based on embodiments, the present disclosure is not limited to the embodiments. Those skilled in the art will readily appreciate that embodiments arrived at by making various modifications to the above embodiments or embodiments arrived at by selectively combining elements disclosed in the above embodiments without materially departing from the scope of the present disclosure may be included within one or more aspects of the present disclosure.

For example, in the above-described embodiments, a sensor is a vehicle speed sensor. However, the sensor is not limited to the vehicle speed sensor, but may be, for example, a camera sensor or the like that images the outside of vehicle 4. Although it has been described that CAN 10 transmits, to vehicular device 2, sensing information indicating the sensing result obtained by the sensor, the present disclosure is not limited to this. It is also possible, for example, that information or the like obtained from another ECU or device is transmitted to vehicular device 2.

Each of the elements in each of the above embodiments may be configured in the form of an exclusive hardware product, or may be realized by executing a software program suitable for the element. Each of the elements may be realized by means of a program executing unit, such as a Central Processing Unit (CPU) or a processor, reading and executing the software program recorded on a recording medium such as a hard disk or semiconductor memory.

It should also be noted that a part or all of the functions in the vehicular device according to the above-described embodiments may be implemented by executing a program by a processor such as a central processing unit (CPU).

It should also be noted that a part or all of the constituent elements included in the above-described device may be implemented into an Integrated Circuit (IC) card or a single module which is attachable to and removable from the device. The IC card or the module is a computer system including a microprocessor, a ROM, a RAM, and the like. The IC card or the module may include the above-described super multi-function LSI. The microprocessor operates according to the computer program to cause the IC card or the module to execute its functions. The IC card or the module may have tamper resistance.

The present disclosure may be the above-described methods.

These methods may be a computer program executed by a computer, or digital signals forming the computer program. The present disclosure may be a computer-readable recording medium on which the computer program or the digital signals are recorded. Examples of the computer-readable recording medium are a flexible disk, a hard disk, a Compact Disc-Read Only Memory (CD-ROM), a magnetooptic disk (MO), a Digital Versatile Disc (DVD), a DVD-ROM, a DVD-RAM, a BD (Blu-ray (registered trademark) Disc), and a semiconductor memory. The present disclosure may be the digital signals recorded on the recording medium. The present disclosure may be implemented by transmitting the computer program or the digital signals via an electric communication line, a wired or wireless communication line, a network represented by the Internet, data broadcasting, and the like. The present disclosure may be a computer system including a microprocessor and a memory. The memory stores the computer program and the microprocessor operates according to the computer program. It is also possible that the program or the digital signals may be recorded onto the recording medium to be transferred, or may be transmitted via a network or the like, so that the program or the digital signals can be executed by a different independent computer system.

While various embodiments have been described herein above, it is to be appreciated that various changes in form and detail may be made without departing from the spirit and scope of the present disclosure as presently or hereafter claimed.

### Further Information about Technical Background to this Application

The disclosure of the following patent application including specification, drawings, and claims are incorporated herein by reference in their entirety: Japanese Patent Application No.

### INDUSTRIAL APPLICABILITY

The vehicular device according to the present disclosure is applicable to, for example, an integrated ECU that has a function of monitoring an in-vehicle system of a vehicle.

1. A vehicular device provided to a vehicle including an output device for presenting information to a driver of the vehicle, the vehicular device comprising:
an operating system that transmits the information to the output device;
a virtual environment in which the operating system runs;
a monitor that monitors at least one of: presence or absence of an anomaly in the operating system; or presence or absence of an anomaly in communication between the operating system and the output device; and
a blocker that blocks the communication between the operating system and the output device when the monitor detects the anomaly in the operating system or the anomaly in the communication between the operating system and the output device.

2. The vehicular device according to claim 1,
wherein the vehicle further includes an in-vehicle network including a sensor that performs sensing on the vehicle or a surrounding environment of the vehicle, the in-vehicle network being a network that transmits, to the operating system via the virtual environment, sensing information indicating a result of the sensing performed by the sensor, and
the operating system obtains the sensing information from the in-vehicle network and generates the information based on the sensing information obtained.

3. The vehicular device according to claim 2,
wherein the monitor further monitors at least one of: presence or absence of an anomaly in the in-vehicle network; or presence or absence of an anomaly in communication between the operating system and the in-vehicle network, and
the blocker further blocks the communication between the operating system and the in-vehicle network when the monitor detects the anomaly in the in-vehicle network or the anomaly in the communication between the operating system and the in-vehicle network.

4. The vehicular device according to claim 3, further comprising:
a substituter that, when the blocker blocks the communication between the operating system and the in-vehicle network, generates substitutive sensing information that substitutes for the sensing information and then transmits, to the operating system, the substitutive sensing information generated,
wherein the operating system generates the information based on the substitutive sensing information received from the substituter.

5. The vehicular device according to claim 2, further comprising:
a substituter that, when the blocker blocks the communication between the operating system and the output device, generates, based on the sensing information received from the in-vehicle network, substitutive information that substitutes for the information and then transmits, to the output device, the substitutive information generated.

6. The vehicular device according to claim 1,
wherein the monitor and the blocker run in the virtual environment.

7. The vehicular device according to claim 1, further comprising:
a management operating system that runs in the virtual environment,
wherein the monitor and the blocker run on the management operating system.

8. A control method used by a vehicular device provided to a vehicle including an output device for presenting information to a driver of the vehicle, the vehicular device including an operating system and a virtual environment in which the operating system runs, the control method comprising:
(a) transmitting the information from the operating system to the output device;
(b) monitoring at least one of: presence or absence of an anomaly in the operating system; or presence or absence of an anomaly in communication between the operating system and the output device; and
(c) blocking the communication between the operating system and the output device when the anomaly in the operating system or the anomaly in the communication between the operating system and the output device is detected in (b).
